(19) United States
(12) Patent Application Publication
(10) Pub. No.: US 2010/0221837 A1
(43) Pub. Date: Sep. 2, 2010

(54) METHOD FOR EXAMINING ION-CONDUCTIVE ELECTROLYTE MEMBRANE

(76) Inventor: Naoki Uchiyama, Shizuoka (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/664,546

(22) PCT Filed: Jun. 2, 2008
(86) PCT No.: PCT/JP2008/060163

§ 371 Date: Dec. 14, 2009

(30) Foreign Application Priority Data
Jun. 14, 2007 (JP) 2007-157515

(51) Int. Cl. G01N 31/00

(52) U.S. Cl. 436/3

(57) ABSTRACT

A light-control membrane (11) is joined to a first surface (10a) of an electrolyte membrane (10), and hydrogen gas is supplied to a second surface (10b) side of the electrolyte membrane (10). If the electrolyte membrane (10) has a defect (10c), such as a crack or a pinhole, the hydrogen gas leaks through the defect (10c) to the first surface (10a) of the electrolyte membrane (10). In result, the light-membrane (11) is hydrogenated by the leaked hydrogen gas, and the reflectance of the light-control membrane (11) is locally changed. This makes it possible to visually spot the presence of the defect (10c).

### TECHNICAL FIELD

The present invention relates to a method for examining a defect of an ion-conductive electrolyte membrane.

### BACKGROUND ART

An ion-conductive electrolyte membrane (hereinafter, occasionally referred to simply as “electrolyte membrane”) is used, for example, in a fuel cell. A hydrogen ion-conductive electrolyte membrane using hydrogen-ion conductivity is utilized, for example, in a membrane electrode assembly of a solid polymer fuel cell. The membrane electrode assembly is constructed by joining a hydrogen electrode (fuel electrode) to one side of a solid polymer membrane serving as a hydrogen ion-conductive electrolyte membrane and joining an air electrode (oxygen electrode) to the other side of the solid polymer membrane. In the solid polymer fuel cell, hydrogen and oxygen (or air) are supplied to the hydrogen and air electrodes, respectively. The hydrogen is ionized at the hydrogen electrode to create hydrogen ions and electrons. The hydrogen ions permeate through the electrolyte membrane to reach the air electrode. The electrons produced at the hydrogen electrode pass through an electrical load connected between the hydrogen and air electrodes to reach the air electrode. At the air electrode to which the electrons have been supplied, the hydrogen ions and oxygen react with each other to form water (water vapor).

In the solid polymer fuel cell that generates electric power in the above-described manner, if there is a pinhole or a crack in the electrolyte membrane constructing a part of the membrane electrode assembly, gas leakage occurs in the electrolyte membrane, and power generation capacity is deteriorated. Such a pinhole or a crack causes hydrogen-gas leakage in the electrolyte membrane, for example, when hydrogen gas is supplied into a space facing one side of the electrolyte membrane. This means that the pinhole or crack can be found by measuring, with a hydrogen sensor, the hydrogen concentration in a space facing the other side of the electrolyte membrane. Hydrogen sensors used for the measurement include, for example, one using a hydrogen-storing alloy. Such a sensor is disclosed, for example, in Unexamined Japanese Patent Publication No. 2004-233097.

However, the measurement of concentration of the leaked hydrogen gas contained in an atmosphere by means of the hydrogen sensor merely examines the presence of a pinhole and the like in an indirect manner, and is not capable of directly inspecting the position, size, etc. of a pinhole and the like in the electrolyte membrane.

### DISCLOSURE OF THE INVENTION

The invention has been made in light of the above problem. The object of the invention is to provide a method capable of directly inspecting a defect, such as a pinhole or a crack, in an electrolyte membrane.

In order to accomplish the object, a method for examining an ion-conductive electrolyte membrane according to the present invention includes the steps of joining a light-control membrane to a first surface of the ion-conductive electrolyte membrane, and supplying hydrogen gas to a space facing a second surface of the ion-conductive electrolyte membrane. If the ion-conductive electrolyte membrane has a defect that causes hydrogen-gas leakage, the hydrogen gas leaks from the second surface of the ion-conductive electrolyte membrane to the first surface of the ion-conductive electrolyte membrane through the defect. In result, the light-control membrane is hydrogenated by the leaked hydrogen gas and then changed in optical reflectance. In this view, whether or not a defect exists in the ion-conductive electrolyte membrane can be directly and quickly examined by visually observing a local change in the optical reflectance of the light-control membrane.

In the method for the examination, preferably, gas pressure in the space facing the second surface of the ion-conductive electrolyte membrane may be kept higher than gas pressure in the space facing the first surface of the ion-conductive electrolyte membrane. In this case, the amount of the leaked hydrogen gas through the defect is increased. In result, the optical reflectance of the light-control membrane is locally and more noticeably changed in an area of the light-control membrane adjacent to a leaking spot. It is therefore possible to examine more quickly whether or not the electrolyte membrane has a defect.

In the method for the examination, for example, the light-control membrane includes a catalyst layer and a reaction layer. If the catalyst layer is in contact with the ion-conductive electrolyte membrane, the reaction layer can be hydrogenated under the catalytic action of the catalyst layer by the hydrogen gas that has leaked through the defect of the ion-conductive electrolyte membrane, and thereby the optical reflectance of the light-control membrane is changed.

More specifically, the reaction layer may be formed of magnesium-nickel alloy, magnesium-titanium alloy, magnesium-niobium alloy, magnesium-vanadium alloy or magnesium, for example. The catalyst layer may be formed of palladium or platinum, for example. In this case, the light-control membrane reacts with hydrogen, and the optical reflectance is quickly and reversibly changed.

### BRIEF DESCRIPTION OF THE DRAWINGS

FIG. 1 is a schematic configuration view showing one configuration example in which a light-control membrane is joined to an electrolyte membrane that is a subject to be examined for a defect, such as a pinhole, of the electrolyte membrane by using an examination method according to one embodiment of the present invention;

FIG. 2 is a schematic view showing an example of hydrogen-gas leakage in the electrolyte membrane shown in FIG. 1;

FIG. 3 is a perspective view of the electrolyte membrane shown in FIG. 1; and

FIG. 4 is a view showing one configuration example in which the electrolyte membrane or the like is contained in a container to inspect a defect, such as a pinhole, of the electrolyte membrane by using an examination method according to one embodiment of the invention.

### BEST MODE OF CARRYING OUT THE INVENTION

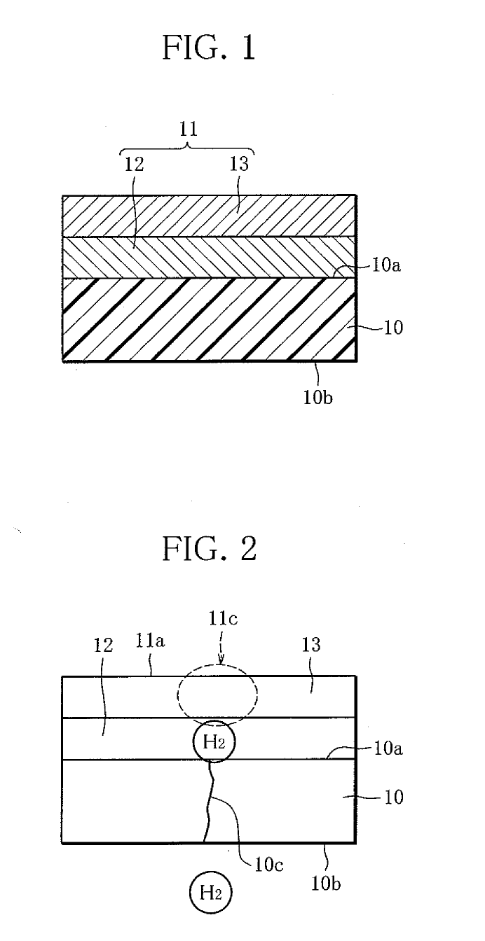

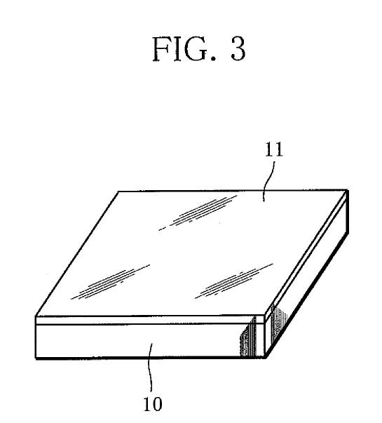

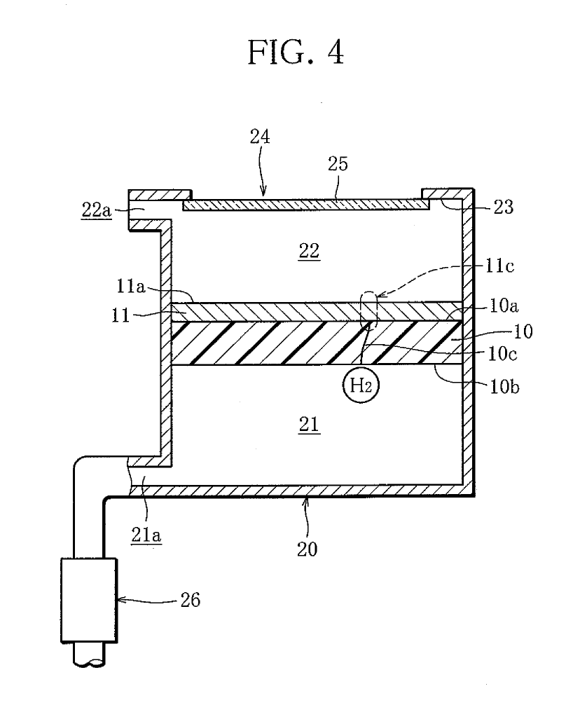

A method for examining an ion-conductive electrolyte membrane according to one embodiment of the present invention will be described below in detail with reference to FIGS. 1 to 4. FIG. 1 is a view showing one configuration example in which a light-control membrane is joined to the electrolyte membrane to be examined. FIG. 2 is a schematic view showing an example of hydrogen-gas leakage in the electrolyte membrane shown in FIG. 1. FIG. 3 is a perspective view of the electrolyte membrane shown in FIG. 1. FIG. 4 is a view showing a schematic configuration example, in which the electrolyte membrane or the like shown in FIG. 1 is contained in a container for the examination.

As illustrated in FIGS. 1 to 3, a light-control membrane 11 having the same flat-face shape as an electrolyte membrane 10 includes a catalyst layer 12 and a reaction layer 13. The catalyst layer 12 is in contact with a first surface 10a of the electrolyte membrane 10. Reference mark 10b shown in FIGS. 1 and 2 represents a second surface of the electrolyte membrane 10. The electrolyte membrane 10 may be, for example, a perfluorosulfonic group polymer membrane, a Nation membrane or the like, each being a solid polymer membrane. The reaction layer 13 included in the light-control membrane 11 is a thin of elemental composition MgNix (0≦x<0.6), for example. Alternatively, the reaction layer 13 may be formed of magnesium-titanium alloy, magnesium-niobium alloy, magnesium-vanadium alloy or magnesium. The catalyst layer 12 is formed of palladium or platinum, for example, and may be formed on a surface of the reaction layer 13 by coating. The catalyst layer 12 has a thickness in a range from 1 nm to 100 nm.

If the light-control membrane 11 thus constructed is exposed to an atmosphere having a hydrogen concentration of about 100 ppm to 1 percent or higher, for example in several to about 10 seconds, the reaction layer 13 is quickly and reversibly hydrogenated, and a visible change occurs in optical reflectance (hereinafter, occasionally referred to as “reflectance”). In short, the reaction layer 13 has high reflectance when not being hydrogenated, and is reduced in reflectance when being hydrogenated.

The light-control membrane 11, in which the reaction layer 13 is formed on a polyethylene sheet, and the catalyst layer 12 is formed thereon, is easy to handle. In this case, the polyethylene sheet is positioned on an upper surface of the light-control membrane 11 in FIG. 1.

When the electrolyte membrane 10 undergoes examination, the electrolyte membrane 10 to which the light-control membrane 11 is joined is arranged in a container 20 as illustrated in FIG. 4, and subsequently, hydrogen gas (H₂) is supplied from a hydrogen-gas supply port 21a of the container 20 into a hydrogen-gas supply space 21 facing the second surface 10b of the electrolyte membrane 10, for example, by means of a pump 26. Gas (air, for example) containing little hydrogen gas is supplied from an air supply port 22a of the container 20 into an air supply space 22 facing the light-control membrane 11 by means of a pump, not shown. The hydrogen-gas supply space 21 and the air supply space 22 are separated from each other by the electrolyte membrane 10. A window 24 for observing the light-control membrane 11 is formed in a wall 23 surrounding the air supply space 22. Glass 25 is put in the window 24 to separate the inside and outside of the container 20. The electrolyte membrane 10 to which the light-control membrane 11 is joined is fixed to the inside of the container 20 with its rim tightly held by a frame (not shown).

When there is no defect, such as a crack or a pinhole, in the electrolyte membrane 10, the hydrogen gas supplied into the hydrogen-gas supply space 21 is prevented from contacting the light-control membrane 11 by the electrolyte membrane 10. In result, the light-control membrane 11 is not hydrogenated and not changed in reflectance. For that reason, when a surface 11a of the light-control membrane 11 is observed, the light-control membrane 11 has high, uniform reflectance and looks like a mirror surface.

On the other hand, when there is a crack 10c (defect) in the electrolyte membrane 10, the hydrogen gas (H₂) leaks out from the second surface 10b of the electrolyte membrane 10 through the crack 10c to the first surface 10a of the electrolyte membrane 10 as illustrated in FIGS. 2 and 4. A section 11c of the light-control membrane 11 adjacent to the crack 10c is rapidly reduced in reflectance according to the amount of the hydrogen gas (H₂) that has leaked. The section 11c is therefore visible as a spot in the light-control membrane 11.

The joining of the light-control membrane 11 and the first surface 10a of the electrolyte membrane 10 does not mean tight adhesion only, in which no gap is created between the two membranes. This is because the hydrogen gas that has leaked through the crack 10c is able to hydrogenate the reaction layer 13 located close to the crack 10c even if a narrow gap is produced when the two membranes are joined together.

When the hydrogen ion-conductive electrolyte membrane is examined, a hydrogen electrode may be joined to the second surface 10b of the electrolyte membrane 10. The reason is that, when there is a defect in the electrolyte membrane 10, the hydrogen gas permeates through the hydrogen electrode, leaks through the defect to the first surface 10a of the electrolyte membrane 10, and then hydrogenates the reaction layer. Consequently, it is possible to examine a semi-finished product of a membrane electrode assembly in which the hydrogen electrode is joined to the hydrogen ion-conductive electrolyte membrane for a defect. Furthermore, by joining the hydrogen electrode to the electrolyte membrane 10, the thickness of the hydrogen electrode is added to that of the assembly of the light-control membrane 11 and the electrolyte membrane 10 (both the membranes are very thin), thereby facilitating the handling of the electrolyte membrane and the like.

Preferably, the pump 26 is used to supply hydrogen gas and the gas pressure in the hydrogen gas supply space 21 is kept higher than the gas pressure in the air supply space 22. This makes it possible to increase the hydrogen gas that leaks through the crack 10c, regardless of whether or not the hydrogen electrode is joined to the electrolyte membrane 10. In this case, a device other than the pump 26 may be utilized as long as the device is capable of maintaining the gas pressure in the hydrogen-gas supply space 21 higher than the gas pressure in the air supply space 22.

As described above, according to the examination method of the present embodiment, it is possible to rapidly inspect the presence of a defect that causes hydrogen-gas leakage, the position of the defect, and the shape of the defect by observing the light-control membrane 11 visually. Instead of visual observation, if the reflectance of the light-control membrane 11 is converted into an electronic signal by means of a television camera or the like, it is possible to detect a change in reflectance by using an image processor and to rapidly inspect a defect of the electrolyte membrane 10.

The electrolyte membrane does not necessarily have a flat-plate shape as in the embodiment, and may have another flat-face shape. If the electrolyte membrane is in the shape of a tube, it is optionally possible to join a light-control membrane onto an outer circumferential surface of the tubular electrolyte membrane, and supply hydrogen gas into a space inside the tube.

The application of the invention is not limited to the examination of the ion-conductive electrolyte membrane used in the membrane electrode assembly of a solid polymer fuel cell, and is not limited to the foregoing embodiment. The invention, on the contrary, can be carried out in properly modified ways without departing from the scope and spirit of the invention.

1. A method for examining an ion-conductive electrolyte membrane, comprising the steps of:
joining a light-control membrane to a first surface of the ion-conductive electrolyte membrane;
supplying hydrogen gas to a space facing a second surface of the ion-conductive electrolyte membrane; and
determining whether or not the ion-conductive electrolyte membrane has a defect depending on a change in an optical reflectance of the light-control membrane, which is hydrogenated by the hydrogen gas leaking from the second surface of the ion-conductive electrolyte membrane to the first surface of the ion-conductive electrolyte membrane through the defect in case where the ion-conductive electrolyte membrane has the defect.

2. The method for examining the ion-conductive electrolyte membrane according to claim 1, wherein gas pressure in the space facing the second surface of the ion-conductive electrolyte membrane is kept higher than gas pressure in a space facing the first surface of the ion-conductive electrolyte membrane.

3. The method for examining the ion-conductive electrolyte membrane according to claim 1, wherein
the light-control membrane includes a catalyst layer and a reaction layer; and
the reaction layer is hydrogenated under catalytic action of the catalyst layer in contact with the ion-conductive electrolyte membrane by the hydrogen gas that has leaked through the defect of the ion-conductive electrolyte membrane.

4. The method for examining the ion-conductive electrolyte membrane according to claim 3, wherein
the reaction layer is formed of magnesium-nickel alloy, magnesium-titanium alloy, magnesium-niobium alloy, magnesium-vanadium alloy or magnesium; and
the catalyst layer is formed of palladium or platinum.
